(19) United States
(12) Patent Application Publication
(10) Pub. No.: US 2007/0081132 A1
(43) Pub. Date: Apr. 12, 2007

(54) PROJECTOR WITH A LENS CAPABLE OF SHIFTING IN TWO DIMENSIONS

(76) Inventor: Hsin-Hung Li, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/467,150

(22) Filed: Aug. 24, 2006

(30) Foreign Application Priority Data
Oct. 6, 2005 (TW) 094135003

(51) Int. Cl. G03B 3/00; G03B 21/14

(52) U.S. Cl. 353/101

(57) ABSTRACT

A projector includes a housing including an opening, and a fixture installed on the opening of the housing. A slot is formed on the fixture. The projector further includes a lens-shading ring installed on the fixture in a slidable manner inside the slot, and a lens for projecting images. An end of the lens is installed inside the housing in a slidable manner inside the lens-shading ring.

### BACKGROUND OF THE INVENTION

1. Field of the Invention

The present invention relates to a projector, and more particularly, to a projector with a lens capable of shifting in two dimensions.

2. Description of the Prior Art

Projectors are conventionally used in conference briefings in which a host projects data or graphics onto a screen for familiarizing attendants with a presentation. With the rapid development of technology, projectors are now widely used in other applications. With high-power hi-fi equipment, large-capacity digital video discs (DVDs), and the large images that can be generated by projectors, it is now possible to reconstruct at home visual and audio effects similar to those provided in a movie theater.

If there is a gap between a lens and a housing of a projector, light can leak from such a gap and cause a user to feel discomfort from stray light. However, most of the conventional lens-shading mechanisms only apply to a fixed-type lens, and few conventional lens-shading mechanisms apply to a movable-type lens capable of being moved in one dimension. There is no lens-shading mechanism for a 2-D movable-type lens that is hidden inside the housing and is capable of moving in two dimensions (upward and downward, forward and backward).

### Summary of the Invention

It is therefore a primary objective of the claimed invention to provide a projector for solving the above-mentioned problem.

According to the claimed invention, a projector includes a housing including an opening, and a fixture installed on the opening of the housing. A slot is formed on the fixture. The projector further includes a lens-shading ring installed on the fixture in a slidable manner inside the slot, and a lens for projecting images. An end of the lens is installed inside the housing in a slidable manner inside the lens-shading ring.

These and other objectives of the present invention will no doubt become obvious to those of ordinary skill in the art after reading the following detailed description of the preferred embodiment that is illustrated in the various figures and drawings.

### Brief Description of the Drawings

FIG. 1 is a diagram of a projector according to the present invention.

FIG. 2 is a diagram of a fixture as shown in FIG. 1 according to the present invention.

FIG. 3 is a diagram of a lens-shading ring as shown in FIG. 1 according to the present invention.

FIG. 4 is a diagram of a lens moving forward and backward inside the lens-shading ring according to the present invention.

FIG. 5 is a diagram of the lens moving upward and downward according to the present invention.

### DETAILED DESCRIPTION

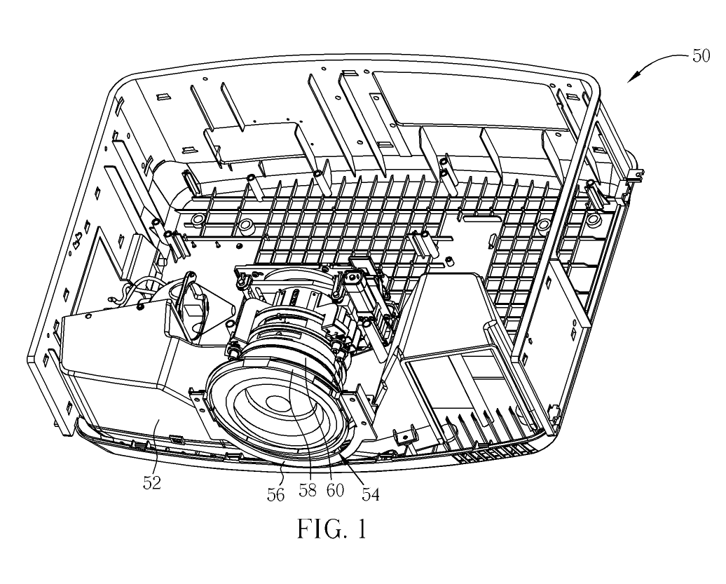

Please refer to FIG. 1. FIG. 1 is a diagram of a projector 50 according to the present invention. The projector 50 includes a housing 52 for covering internal components of the projector 50. An opening 54 is positioned on the housing 52. The projector 50 further includes a fixture 56 installed on the opening 54 of the housing 52, a lens-shading ring 58 installed on the fixture 56, and a lens 60 for projecting images. An end of the lens 60 is installed inside the housing 52 in a slidable manner inside the lens-shading ring 58.

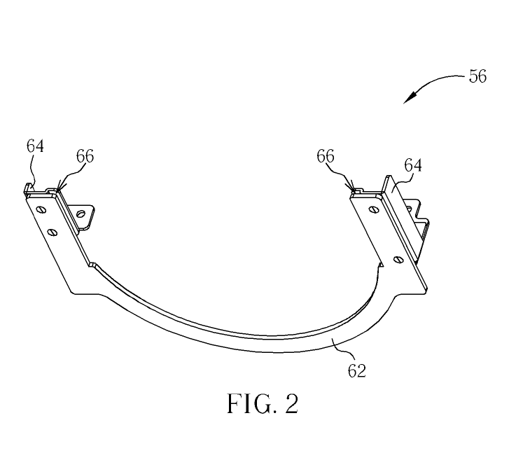

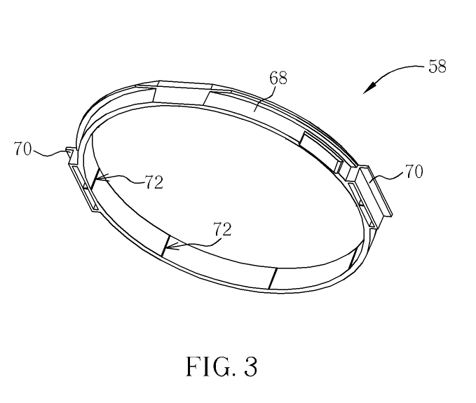

Please refer to FIG. 1 and FIG. 2. FIG. 2 is a diagram of the fixture 56 as shown in FIG. 1 according to the present invention. The fixture 56 includes an annular frame 62 installed on the opening 54 of the housing 52, and two clamping means 64 connected to two sides of the annular frame 62 for forming two slots 66 between the annular frame 62 and the two clamping means 64. Please refer to FIG. 1, FIG. 2, and FIG. 3. FIG. 3 is a diagram of the lens-shading ring 58 as shown in FIG. 1 according to the present invention. The lens-shading ring 58 includes a main body 68 and two slides 70 connected to an outer side of the main body 68 and installed inside the two slots 66 in a slidable manner. The lens-shading ring 58 includes at least one protruding bar 72 installed on an inner side of the main body 68 for contacting the lens 60 so as to prevent the lens 60 from contacting the main body 68 in a planar manner when the lens 60 moves forward and backward inside the main body 68. This can reduce friction force between the lens 60 and the main body 68. In addition, the tolerance of the protruding bar 72 contacting the lens 60 (point-and-plane contact) is less than the tolerance of the inner side of the main body 68 directly contacting the lens 60 (plane-and-plane contact) so that it is easy to manufacture and assemble.

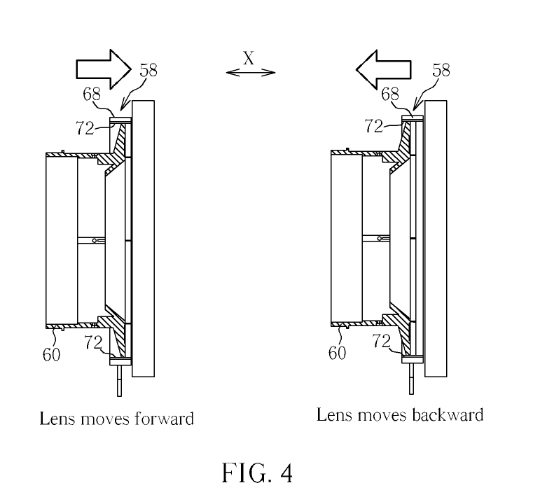

Please refer to FIG. 3 and FIG. 4. FIG. 4 is a diagram of the lens 60 moving forward and backward inside the lens-shading ring 58 according to the present invention. When the lens 60 moves in the X direction, the lens 60 slides along the protruding bars 72 on the inner side of the main body 68. The main body 68 sheathes the lens 60 to prevent light from leaking out.

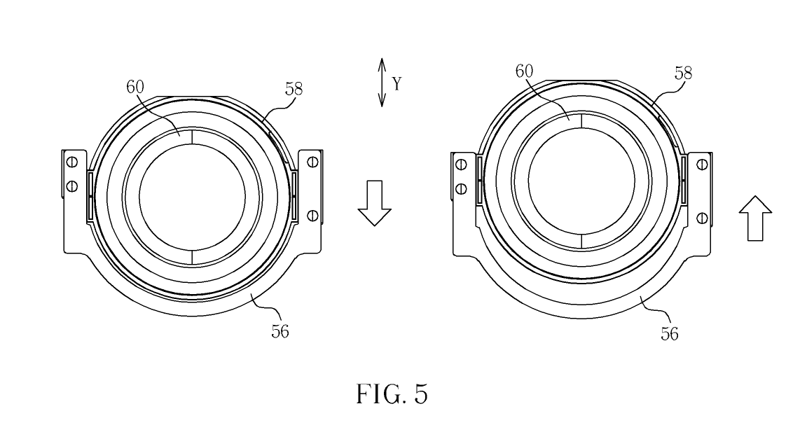

Please refer to FIG. 2, FIG. 3, and FIG. 5. FIG. 5 is a diagram of the lens 60 moving upward and downward according to the present invention. When the lens 60 moves in the Y direction, the slides 70 of the lens-shading ring 58 slide along the slots 66 of the fixture 56 so that the lens-shading ring 58 can move upward and downward on the fixture 56 to drive the lens 60 inside the lens-shading ring 58 to move upward and downward. Because the lens-shading ring 58 moves upward and downward as a whole, there is no light leaking out.

In the present invention, the main body 68 sheathes the lens 60, so the lens 60 can move forward and backward inside the lens-shading ring 58 without leaking light. In addition, the lens-shading ring 58 moves upward and downward as a whole on the fixture 56 for driving the lens 60 inside the lens-shading ring 58 to move upward and downward, so there is no light leaking out. The present invention provides a 2-D lens-shading mechanism utilized for the lens 60 capable of moving in two dimensions (forward and backward, upward and downward).

In contrast with the conventional projector, the projector according to the present invention includes a 2-D lens-shading mechanism utilized for a lens capable of moving in two dimensions (forward and backward, upward and downward) so as to solve the problem of light leakage. The present invention can increase the quality of image projection for a projector.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projector comprising:
a housing comprising an opening;
a fixture installed on the opening of the housing, a slot being formed on the fixture;
a lens-shading ring installed on the fixture in a slidable manner inside the slot; and
a lens for projecting images, an end of the lens being installed inside the housing in a slidable manner inside the lens-shading ring.

2. The projector of claim 1 wherein the fixture comprises:
an annular frame installed on the opening of the housing; and
two clamping means connected to two sides of the annular frame for forming two slots between the annular frame and the two clamping means.

3. The projector of claim 2 wherein the lens-shading ring comprises:
a main body; and
two slides connected to an outer side of the main body and installed inside the two slots in a slidable manner.

4. The projector of claim 3 wherein the lens-shading ring comprises a protruding bar installed on an inner side of the main body for contacting the lens.

5. The projector of claim 4 wherein the protruding bar is monolithically connected to the main body.
